(19) United States
(12) Patent Application Publication
(10) Pub. No.: US 2008/0309092 A1
(43) Pub. Date: Dec. 18, 2008

(54) Power Generator

(75) Inventor: Sven Erik Prytz, Lidingo (SE)

Correspondence Address: KNOBBE MARTENS OLSON & BEAR LLP, 2040 MAIN STREET, FOURTEENTH FLOOR, IRVINE, CA, 92614, US

(73) Assignee: Sven Erik Prytz

(21) Appl. No.: 11/997,899

(22) PCT Filed: Aug. 3, 2006
(86) PCT No.: PCT/SE2006/000929

§ 371 Date: Aug. 29, 2008

Related U.S. Application Data
(60) Provisional application No. 60/705,293, filed on Aug. 3, 2005.

(51) Int. Cl. H02K 7/18; H02K 53/00

(52) U.S. Cl. 290/1 A; 415/916

(57) ABSTRACT

The invention relates to a closed system (80) power generator/engine (26, 10) combining the symbiotic relationships between different energy elements to improve efficiency of combusting fuel. Hereby, a reaction chamber driven by hydrogen/LQ-gas providing combustion fuel is provided to drive an engine. A Wankel combustion engine (34) driven by the hydrogen fuel, driving a turbine engine (48) driven by the Wankel engine (34) exhaust gases (22, 40) is provided.

### TECHNICAL FIELD

The present invention pertains to a power generator combining the symbiotic relationships between different energy elements to improve efficiency of combusting fuel, and a method therefore.

### BACKGROUND ART

It has been estimated that the equivalent of ten new Saudi Arabia oil fields must be in production 2025 to meet the demand of fuel and other oil based products. With this increased regional conflicts will probably emerge over oil findings.

Utilizing oil as fuel is a question of great concern for the biosphere and peoples life quality. The internal combustion engine (ICE) and the existing problems related to its usage, besides oil shortages, comprises that the society is dependent on energy that creates pollution and related dangers, it is contributing to global warming and climate problems, it creates health problems with toxic fumes, and wastes and misuses energy. Currently, the internal combustion engine is married to high rates of oil consumption. Since its birth, its fuel efficiency has increased only slightly, lagging behind the technical developments of other industries such as the telecom, computer, and medicine to name a few.

Production of carbon dioxide in the combustion process of oil based fuels greatly increases the so called green house gas effect. A growing body of evidence suggests this is accelerating leading earth towards an ecological disaster of planetary proportions.

Regarding toxic fumes, the WHO in its year 2000 health report submitted that air pollution, of which the ICE is a major contributor, kills 3,000,000 per year world wide.

Traditional bio fuels like ethanol provide some relief to oil consumption, but the combustion process still wastes energy. If society were to switch to using bio fuels instead of the 80 mbd of oil, mostly used for transportation purposes, a need of about 58,000,000 sugar cane fields the size of football fields must be planed according to science. If society were to switch to natural gas considering it could be brought on line fast enough there may be enough gas for 50 years. None of these alternatives to oil are truly renewable.

Hence, there is an obvious need for a fuel that sets aside the problems related to current combustion type of fuels and its machinery.

### SUMMARY OF THE INVENTION

The present invention appreciates that hydrogen and machinery operated by hydrogen mixtures and a special combined gas, generated on-demand by the inventions catalytic system, bearing the chemical formula 2H₂+O₂ gas/Hydro-Oxygen gas, henceforth named LQ-gas throughout the present description, which can be mixed with gasoline, methane, ethanol, diesel or other specialized fuel mixtures provides a source of solving or at least relieving society from the problems mentioned. Hydrogen and the inventions specially generated LQ-gas is considered completely renewable, and there are actually no alternatives to its usage currently recognized. The LQ-gas has a supported behaviour when it burns and does not need external oxygen to react, thus releasing the energy very efficiently with no pollution to the sounding environment, and perfect to be utilized in the present invention closed recycling system.

Correspondingly, the present invention sets forth a power generator combining the symbiotic relationships between different energy elements to improve efficiency of combusting fuel. The invention comprises:

a container comprising a hydrogen, oxygen, water gaseous mixture;

a reaction chamber producing fuel to drive an engine in controlled frequencies;

a re-circulate container of combusted fuel;

a Wankel combustion engine driven by the 2H₂+O₂ gas mixture of fuel, driving a turbine engine, having at least one flywheel equipped with magnets at its tips, by the Wankel engine exhaust gases;

at least one rotating chamber attached to the magnets, and at least partly enclosing the turbine engine;

polarized controlled electrical collectors surrounding the rotating chamber, collecting the electric current in the collectors induced by the flywheel and rotating chamber, through inter-correlated magnetic fields, utilizing the induced magnetic fields to build up electric currents, enabling the generator to operate as a hybrid engine both generating electricity and running as an engine;

at least one thermal shield enclosing the collectors and the turbine engine at least partly, transforming engine heat to electricity; and

an outer heat absorbing layer surrounding the thermal shield, collecting remaining heat, pre-heating water to produce fuel in the reaction chamber to further enhance an ongoing recycling energy process.

One embodiment of the present invention comprises an electro chemical reaction in said reaction chamber is catalyzing separation of hydrogen and oxygen out of water with frequencies by controlled electro magnetic energy pulses forming the special hydrogen/LQ-gas, said separation is increased by combination of aluminum-peroxide liquid and supported by the pre-heating.

Another embodiment comprises that the hydrogen/LQ-gas is utilized to boost combustion when mixed with gasoline, methane, ethanol, diesel or other specialized fuel mixtures.

A further embodiment comprises that the generator is utilized as an engine to drive a vehicle or other known machinery.

Still a further embodiment comprises that the generator is connected in series with others of the generator through a transmission means, thus producing increased output power.

Moreover, the present invention sets forth a method to a power generator combining the symbiotic relationships between different energy elements to improve efficiency of combusting fuel. The method comprises:

having a container comprising a hydrogen, oxygen, water gaseous mixture;

having a reaction chamber producing fuel to drive an engine in controlled frequencies;

having a re-circulate container of combusted fuel;

driving a Wankel combustion engine driven by the hydrogen mixture of fuel, driving a turbine engine, having at least one flywheel equipped with magnets at its tips, by the Wankel engine exhaust gases;

having at least one rotating chamber attached to the magnets, and at least partly enclosing the turbine engine;

providing polarized controlled electrical collectors surrounding the rotating chamber, collecting the electric current in the collectors induced by the flywheel and rotating chamber, through inter-correlated magnetic fields, utilizing the induced magnetic fields to build up electric currents, enabling the generator to operate as a hybrid engine both generating electricity and running as an engine;

having at least one thermal shield enclosing the collectors and the turbine engine (48) at least partly, transforming engine heat to electricity; and

having an outer heat absorbing layer surrounding the thermal shield, collecting remaining heat, pre-heating water to produce fuel in the reaction chamber to further enhance an ongoing recycling energy process.

Further embodiments of the method of the present invention are set forth through the set of attached dependent method claims.

### BRIEF DESCRIPTION OF THE DRAWINGS

Henceforth reference is had to the accompanied drawings and its related text, whereby the present invention is described through given examples and provided embodiments for a better understanding of the invention, wherein:

FIG. 1 is schematically illustrating a generator or engine driven by hydrogen/LQ-gas fuel;

FIG. 2 is schematically illustrating how a generator in accordance with the present invention in a closed system uses, produces and stores electricity;

FIG. 3 is schematically illustrating the two engines, Wankel and turbine, which are combined to provide the present invention;

FIG. 4 is schematically illustrating how the turbine engine is constructed in accordance with the present invention;

FIG. 5 is schematically illustrating how the turbine engine is further constructed according to FIG. 4;

FIG. 6 is schematically illustrating how the turbine engine is further constructed according to FIG. 5;

FIG. 7 is schematically illustrating how the turbine engine is constructed according to FIG. 6; and

FIG. 8 schematically illustrates the closed energy producing generator/engine of the present invention.

### DETAILED DESCRIPTION OF PREFERRED EMBODIMENTS

The present invention provides a solution that will make renewable fuels and gasoline last much longer, by usage of the present invention efficient hydrogen/LQ-gas energy engine/generator or by mixing with a fuel booster of the present invention. The invention hydrogen/LQ-gas engine/generator takes into consideration the demands for the fuel which are continually renewable and utilizing the existing weather conditions. Hydrogen provides an inexhaustible source that can supply current societies growing energy demands, and it is easy to produce, easily stored and transportable. It is usable in all weather and climate conditions, and proven reliable in performance with a long track record of success, and can be produced locally almost anywhere. Hereby, it is able to support the total energy needs both for driving, home and industry needs.

One kilo of hydrogen provides the equivalent energy as 4 litres of gasoline. The hydrogen contained in 10 litres of water replaces 4 litres of gasoline. Current automobiles internal combustion engines utilize 15%-20% of the energy in gasoline whereas a hydrogen fuel cell can convert 40%-65% of its inherent energy into electricity to power a car. Gaseous hydrogen is 14 times lighter than air and 4 times lighter than helium. If it is released by accident, hydrogen disperses rapidly into the atmosphere not lingering as a dangerous explosive or toxic concern as the case with gasoline.

Pure hydrogen produces only heat energy, water and minute traces of oxides of nitrogen when burned. Oxides of nitrogen and water are natural to our planet's atmosphere. One pound of hydrogen combined with oxygen will make nine pounds of water. This means that a hydrogen power plant could induce electricity and produce pollutant-free distilled water. Further the LQ-gas produced by the invention is used in the inventions closed recycling system making it safe for the environment in any matters.

Benefits of hydrogen/LQ-gas as a fuel includes not only zero emissions of pollutants, but it actually cleans the air as driving for instance a vehicle. One hydrogen car cleans the exhaust of three gasoline cars. Hydrogen burns cooler than other fuels, and therefore less heat energy is lost, and provides less heat related wear on an engine, i.e., promotes longer lasting engines. It burns 10 times quicker then gasoline providing that the firing to drive for instance a piston can occur at the top dead centre of a combustion cycle reducing wear on engine and heat loss while increasing efficiency. Furthermore, hydrogen combustion produces pure water safe to drink.

There are numerous myths related to storing of hydrogen for instance that steel can not hold hydrogen, de facto tanks/containers holding hydrogen pressurized at 2000 PSI for 88 years (since 1917) have been found. Low alloy steel containers and pipelines which currently transfer natural gas can also transfer hydrogen without losses. Another myth is that a Hydrogen tank in a vehicle is a dangerous bomb. The fact is that much more dangerous explosive materials are commonly transported on the roads or by railway. A test conducted with a rear end collision at 60 mph (90 k/h) revealed a completely intact and undamaged hydrogen tank in the trunk of a typical passenger car.

Also, taking into consideration, the invention utilizing the gas creation on-demand out of water provides a need for storage to a minimum.

It has also been alleged that hydrogen is too expensive to produce. In fact recent inventions technological achievements in hydrogen/LQ-gas development have brought the price of small-scale homeowner size production down to be very competitive with fossil fuels. Governmental and private sector investments in hydrogen have spiked upward right along side the increase gasoline prices at the pump.

A further myth sets forth that hydrogen is a new technology and requires many more years of testing and development to be made practical for mass production. But hydrogen was first used as a fuel source for powering machinery 150 years ago. Since then many applications world wide utilized hydrogen to provide power for transportation and electrical generation.

The source for production of hydrogen is primarily water. To split the water into hydrogen and oxygen is basically accomplished through electrolysis but also through different chemical reactions. Membranes within fuel cells splitting hydrogen are playing a key role.

The present invention provides an electrochemical reaction with special frequent electric and electromagnetic power pulses boosting the separation of hydrogen/LQ-gas out of water. The present invention also utilizes a combination of aluminium oxide and peroxide liquid utilized by preheating speeds up the release of hydrogen 100's of times more than a conventional electrolytic process. These chemicals are viewed as waste by products in some industrial processes.

The present inventions can be utilized for production of a hydrogen/LQ-gas compound when it is mixed with gasoline, diesel, methane, ethanol or other mixtures of fuels. This boosts the conventional combustion reaction to release more energy while lowering the pollutant emission. The boosting efficiency of the fuel is estimated to be in the range of approximately 50%.

It is believed that the capacity of the invention will have a high ramification on society's activities by lowering the costs of energy and fuel and clean water. Moreover, It will enhance the environments ability to repair damages and support the capacity of the Earth's Biosphere for a better life quality.

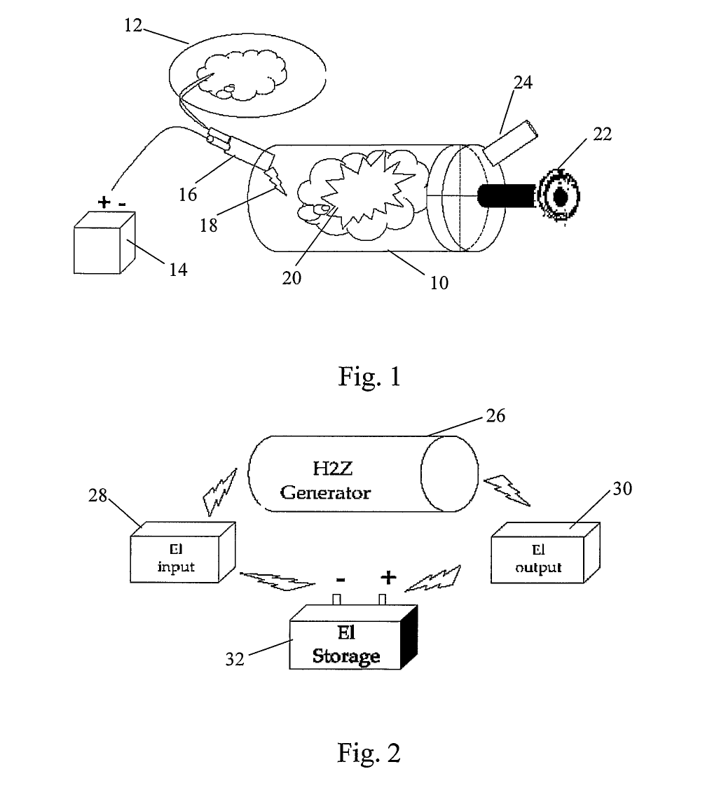

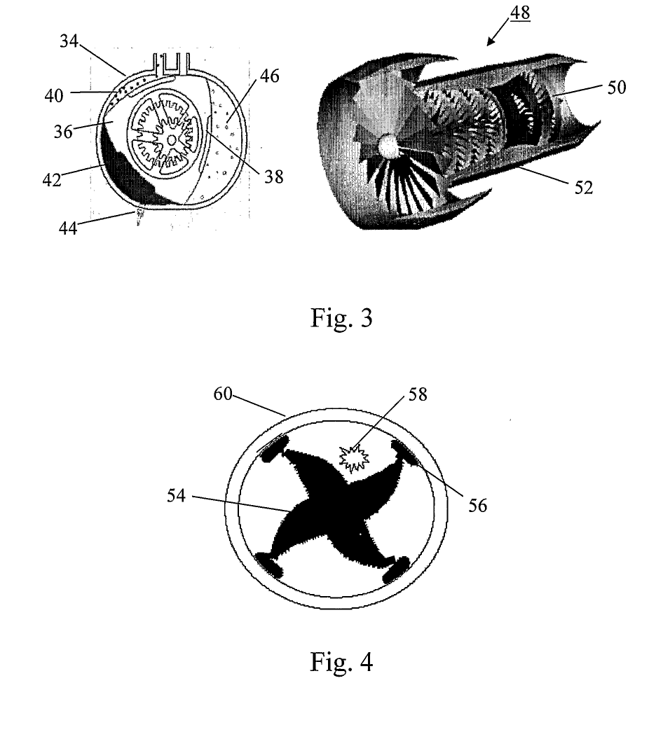

FIG. 1 is schematically illustrating a generator or engine 10 driven by a hydrogen/LQ-gas fuel mixture of aluminium-peroxide held in a container 12. A source for electricity, power control and electric plasma pulse sequence generator, powers an injector valve 16 firing a spark 18 which ignites the hydrogen/LQ-gas fuel mixture, which has been combusted and ignited to a plasma 20, the mixture of exhaust gases, a mixture of water vapour and other gases, are provided a turbine for instance through a duct system 24 to create a torque operating on the turbine engines flywheels in accordance with the present invention, described more in detail by FIG. 3 to FIG. 7. The engine 10 in FIG. 1 combusting the fuel/fuel mixture is a Wankel engine according to the present invention, which axis/crank shaft/shaft is utilized to drive machinery such as for instance a vehicle. Reference numeral 22 symbolizes the output torque of the engine 10.

FIG. 2 is very schematically, to provide an overview, illustrating how a generator 26, including a Wankel type engine and a turbine engine, in accordance with the present invention operates in a closed system, utilizing in one embodiment of the present invention super electrical elements 28, 30 for input and output to utilize and store induced electricity 32, respectively. The electrical storage 32 could, for example, be a battery, and the input of electricity is in one embodiment supported by fuel cells (not shown).

Moreover, the super electrical element is designed to boost electrical in- 28, output 30, and storage 32 utilizing new scientific findings regarding magnetic resonance combining matter with correlated molecular weights as described on www.utele.net.

FIG. 3 is schematically illustrating the two engines, Wankel 34 and turbine 48, which are combined by providing the exhaust gases 22 to drive the turbine 48 to provide the present invention. Thus booth engines 34, 48 are making up the generator 26 and/or engine 10. In one specific embodiment of the invention a gear box arrangement (not shown) synchronizes the output torque from booth engines to one output torque.

A Wankel engine 34 is well known to a person skilled in the art, having a piston 46 with a combustion aperture 38 where the hydrogen based fuel is ignited when combusted. Exhaust gases 40 are led to the turbine through for instance a system of ducts 24 to drive its flywheels in accordance with the present invention. The ignited hydrogen/LQ-gas fuel after being combusted and ignited by a plasma spark plug in the aperture 38 is expanding as plasma 42 and thus driving the piston 34 and its axis clockwise. Also depicted in FIG. 3 is the provided mixture of hydrogen/LQ-gas and other fuels 46.

The turbine 48 is as known to a person skilled in the art built up by flywheels 50 and a housing 52. The turbine engine 48 which makes up a major part of the closed recycle generator/engine 26,10 is explained in greater detail through FIG. 4 to FIG. 7.

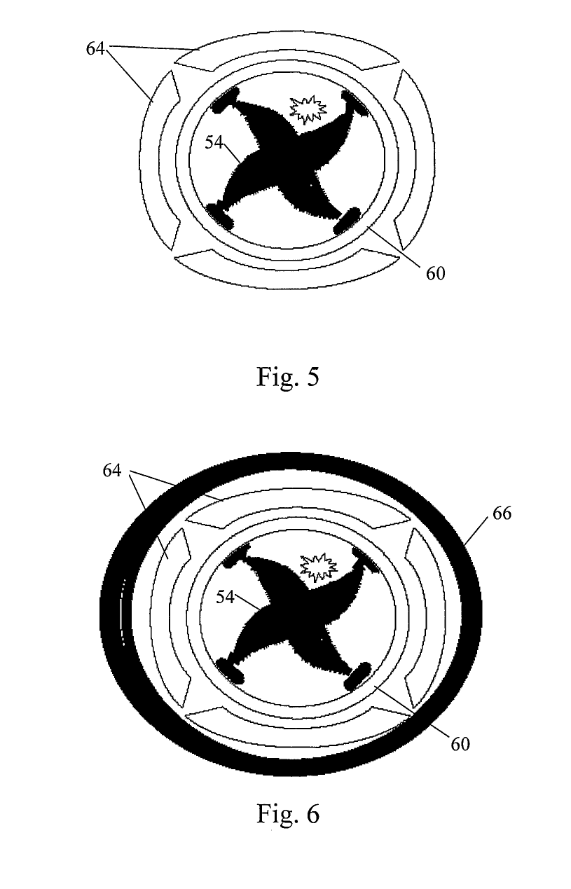

FIG. 4 is schematically illustrating how the turbine engine 48 is constructed in accordance with the present invention. At least one flywheel 54 has magnets 56 applied to its tips and attached to a rotating chamber 60 rotating with the speed of the flywheels 54 producing the turbine engine 48 torque. The exhaust gases 58 are driving the flywheels 54, which are inducing electricity in electrical collectors, see FIG. 5. The rotating chamber(s) 60 covers the turbine in its entire or at lest a part of the turbine 48. Hence the turbine is producing electricity that for instance can be used to reload batteries 14 or otherwise provide electricity.

Moreover, as depicted in FIG. 5, which is schematically illustrating how the turbine engine 48 is further constructed according to FIG. 4. Depicted in FIG. 5 is how collectors 64 for electricity for instance coils, by the induced magnetic fields, are surrounding the rotating chamber 60. The collectors are polarity controlled in order to collect the magnetic energy as efficient as possible.

Furthermore, FIG. 6 is schematically illustrating how the turbine engine 48 is further constructed according to FIG. 5, thus being provided thermal shields 66 enclosing the entire turbine engine 48 or at least parts of it. The shield(s) are thermal elements transforming heat from the turbine 58 into electricity, which further can be utilized to operate and reload the generator/engine 26, 10 according to the present invention. Thermal shields could for instance be manufactured of materials such as so called clathrates utilized in space technology.

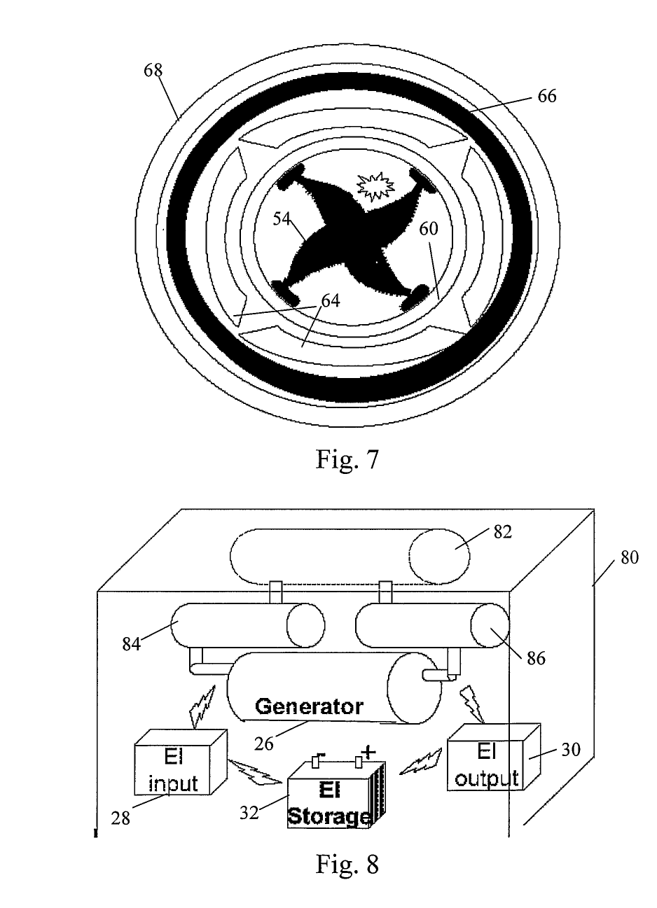

FIG. 7 is schematically illustrating how the turbine engine is further constructed according to FIG. 6. In FIG. 7, the turbine is entirely or at least partly enclosed by a heat-absorbing layer 66, which eliminates remaining heat to pre-heat water utilized to produce hydrogen for improved efficiency of the ongoing recycling energy process provided by the generator/engine 10, 26 according to the present invention.

At least one of the generator 26 or engine 10 of the present invention can operate in series through a clutch, gearbox or other connection means known to a person skilled in the art to connect the shafts of the Wankel engine 34 or combined shafts as described above.

FIG. 8 schematically illustrates the closed energy producing system 80 of the present invention. In FIG. 8 is depicted a fuel refillable tank/container 82 or fuel booster comprising a gaseous mixture of hydrogen/LQ-gas, oxygen, and water, for example, hydrogen aluminium-peroxide, provided to a hydrogen oxygen gas on demand injector container/reaction chamber 84. The injector container 84 comprises an inductive coil, which is controlled to provide, by electric and magnetic power pulses, the split the fuel into hydrogen and oxygen/LQ-gas to be combusted by the Wankel engine 48 in controlled frequencies as required by the generator/engine 26/10. The shaft of the generator/engine is not shown in FIG. 8.

Furthermore, the exhaust gases are provided a container 86, which operates to re-circulate fuel to the tank 82. Heat and other energy loses provide an eventual refill of the tank 82. The units 26, 28, 30, and 32 have previously been described.

One embodiment of application is the construction of an “LQ-Utility Container” where the invented system on-demand provides a distributed energy solution for electricity, LQ-gas and pure water. With this integrated concept a society can in a very cost effective manner safe the environment while expanding the use of clean energy. This pre-built utility module wills also meat the demand for solution in emergency situations. The acronym LQ stands for Life Quality to support the creation of a sustainable society.

Although, the present invention has been described by examples and embodiments, it is appreciated that it is not limited to those, but to what a person skilled in the art can derive from the attached set of claims.

1. A power generator combining the symbiotic relationships between different energy elements to improve efficiency of combusting fuel in a closed environment, comprising:
a container comprising a hydrogen, oxygen, water gaseous mixture;
a reaction chamber producing fuel to drive an engine by controlled electro magnetic frequencies;
a re-circulateing container of combusted fuel;
a Wankel combustion engine driven by said hydrogen mixture of fuel, driving a turbine engine, having at least one flywheel equipped with magnets at its tips, by said Wankel engine exhaust gases;
at least one rotating chamber attached to said magnets, and at least partly enclosing said turbine engine;
polarized controlled electrical collectors surrounding said rotating chamber, collecting said electric current in said collectors induced by said flywheel and rotating chamber, through inter-correlated magnetic fields, utilizing said induced magnetic fields to build up electric currents, enabling said generator to operate as a hybrid engine both generating electricity and running as an engine;
at least one thermal shield enclosing said collectors and said turbine engine at least partly, transforming engine heat to electricity; and
an outer heat absorbing layer surrounding said thermal shield, collecting remaining heat, pre-heating water to produce fuel in said reaction chamber to further enhance an ongoing recycling energy process.

2. A generator according to claim 1, wherein an electro chemical reaction in said reaction chamber is catalyzing separation of hydrogen and oxygen out of water with frequencies by controlled electro magnetic energy pulses forming the hydrogen, oxygen, water, gas, said separation being increased by combination of aluminum-peroxide liquid and supported by the pre-heating.

3. A generator according to claim 1, wherein said separated hydrogen, oxygen, water, gas is utilized to boost a combustion when mixed with gasoline, methane, ethanol, diesel or other specialized fuel mixtures.

4. A generator according to claim 1, wherein said generator is utilized as an engine to drive a vehicle or other type of machinery.

5. A generator according to claim 1, wherein said generator is connected in series with others of said generator through a transmission, thus producing increased output power.

6. A method of generating power by combining the symbiotic relationships between different energy elements to improve efficiency of combusting fuel, by comprising:
having a container comprising a hydrogen, oxygen, water gaseous mixture;
having a reaction chamber producing fuel to drive an engine in controlled frequencies;
having a re-circulateing container of combusted fuel;
driving a Wankel combustion engine driven by said hydrogen mixture of fuel, driving a turbine engine, having at least one flywheel equipped with magnets at its tips, by said Wankel engine exhaust gases;
having at least one rotating chamber attached to said magnets, and at least partly enclosing said turbine engine;
providing polarized controlled electrical collectors surrounding said rotating chamber, collecting said electric current in said collectors induced by said flywheel and rotating chamber, through inter-correlated magnetic fields, utilizing said induced magnetic fields to build up electric currents, enabling said generator to operate as a hybrid engine both generating electricity and running as an engine;
having at least one thermal shield enclosing said collectors and said turbine engine at least partly, transforming engine heat to electricity; and
having an outer heat absorbing layer surrounding said thermal shield, collecting remaining heat, pre-heating water to produce fuel in said reaction chamber to further enhance an ongoing recycling energy process.

7. A method according to claim 6, wherein an electro chemical reaction in said reaction chamber is catalyzing separation of hydrogen and oxygen out of water with frequencies by controlled electro magnetic energy pulses forming the special hydrogen, oxygen, water, gas, said separation is increased by combination of aluminium-peroxide liquid and supported by the pre-heating.

8. A method according to claim 6, wherein said separated hydrogen, oxygen, water, gas is utilized to boost a combustion when mixed with gasoline, methane, ethanol, diesel or other specialized fuel mixtures.

9. A method according to claim 6, wherein said generator is utilized as an engine to drive a vehicle or other type of machinery.

10. A method according to claim 6, wherein said generator is connected in series with others of said generator through a transmission means, thus producing increased output power.
